(19) United States
(12) Patent Application Publication
(10) Pub. No.: US 2012/0033103 A1
(43) Pub. Date: Feb. 9, 2012

(54) Raw-Split Mode Image Capture

(75) Inventors: Brandon Corey, Palo Alto, CA (US); Nikhil Bhogal, San Francisco, CA (US); Andrew Yanowitz, Ben Lomond, CA (US)

(73) Assignee: APPLE INC., Cupertino, CA (US)

(21) Appl. No.: 12/851,491

(22) Filed: Aug. 5, 2010

(51) Int. Cl. H04N 5/76

(52) U.S. Cl. 348/231.6; 348/E05.031

(57) ABSTRACT

Systems, methods and a computer readable mediums for reducing run-time bandwidth requirements within digital image capture devices are disclosed herein. As the resolution of digital image capture devices increase, the bandwidth needed to support this increased resolution is becoming increasingly difficult to support. To reduce the problems associated with run-time bandwidth requirements, it may be beneficial to obtain full-resolution and display-resolution images at the same time from the image capture circuitry—writing both to memory at virtually the same time. The display resolution image may then be delivered to a display unit directly without the need for additional memory operations on the full-resolution image. Only when a user indicates they wish to capture an image need additional memory operations on the full-resolution image be performed.

The present application is related to the commonly-owned application entitled “Image Capturing Device Having Continuous Image Capture,” filed on Jun. 5, 2009 having Ser. No. 12/479,756; which is hereby incorporated by reference in its entirety.

### BACKGROUND

As the field of digital image capture devices matures, the resolution of captured images continues to increase. Where it was initially common for image capture devices such as mobile telephones and still and video cameras to have image sensors of 1-2 megapixels, it is now common for these same devices to provide images having at least 3-5 megapixels. While the increased resolution provides higher quality pictures/images for the user, it also increases the amount of data that must be transported and processed within the device itself.

Referring to FIG. 1, prior art image capture device 100 (e.g., a camera) includes image sensor 105, image capture circuit 110, memory 115, image scaler circuit 120, processor 125, image encoder circuit 130, input-output (I/O) circuit 135, display unit 140, user input means (e.g., image capture button or a touch-screen) 145 and internal communications bus 150. Image capture circuit 110 generates image 155 in some, typically, standard representational format using one of a number of known color spaces such as RGB or YCbCr.

During normal operation image capture device 100 captures a number of full-resolution images each second (e.g., 15 images per second). A low-resolution replica of each full-resolution image (hereinafter referred to as a “preview image”) is then generated and presented to the user through, for example, display 140. At some point in time, a user provides input (e.g., via user input device 145) indicating that one of the images is to be retained. At that time, the full-resolution image corresponding to the preview image being displayed on display 140 at the time the user indicates image capture should occur is encoded in a final format (e.g., the Joint Photographic Experts Group, or JPEG, format) and written or stored to non-volatile storage such as a solid-state or magnetic disk unit (e.g., memory 115).

Referring to FIG. 2, data flow 200 along internal bus 150 is illustrated for a single full-resolution image capture sequence. (That is, if the image capture rate is 15 frames/sec, FIG. 2 shows the data flow during 1/15of a second.) As shown, image capture circuit 110 generates a full-resolution image and writes it to memory 130 (205). The full-resolution image is then read from memory 130 and delivered to scaler circuit 120 (210). Scaler circuit 120 scales the full-resolution image (215) and writes the resulting preview image to memory 130 (220). Finally, the preview image is read from memory 130 and written to display 140 (225).

Table 1, identifies the bandwidth requirements for data flow 200 under the following assumptions: (1) the full-resolution image is 2048×1536 pixels (3 megapixels) and is encoded in 4:2:0 YCbCr format using 1.5 bytes per pixel; (2) the preview image is 852×640 pixels and is also encoded in 4:2:0 YCbCr format using 1.5 bytes per pixel; and (3) the image capture rate is 15 frames per second. Table 2, identifies the bandwidth requirements for data flow 200 under the same assumptions except that the full-resolution image is now 2592×1936 pixels (5 megapixels).

TABLE 1
Example Bandwidth Requirement for Prior Art Image Capture
Operations in a 3 Megapixel Image Capture Device

| Image | Size | | Bytes/Pixel | Read | Write | Bytes/sec |
|---|---|---|---|---|---|---|
| Full | 2048 | 1536 | 1.5 | 1 | 1 | 141,557,760 |
| Preview | 852 | 640 | 1.5 | 1 | 1 | 24,537,600 |

| | |
|---|---|
| Total Bandwidth (Bytes/sec): | 166,095,360 |
| Total Bandwidth (MB/sec): | 158.4 |

TABLE 2
Example Bandwidth Requirement for Prior Art Image Capture
Operations in a 5 Megapixel Image Capture Device

| Image | Size | | Bytes/Pixel | Read | Write | Bytes/sec |
|---|---|---|---|---|---|---|
| Full | 2592 | 1936 | 1.5 | 1 | 1 | 225,815,040 |
| Preview | 852 | 640 | 1.5 | 1 | 1 | 24,537,600 |

| | |
|---|---|
| Total Bandwidth (Bytes/sec): | 250,352,640 |
| Total Bandwidth (MB/sec): | 238.75 |

A comparison of Tables 1 and 2 clearly show that as the resolution of image capture devices increase, so too does the needed internal bandwidth. Thus, to facilitate the use of increased image resolution devices, it would be beneficial to provide a mechanism to reduce the amount of data that must be transferred during image capture operations.

### SUMMARY

As the resolution of digital image capture devices increase, the bandwidth needed to support this increased resolution is becoming increasingly difficult to support. To reduce the problems associated with run-time bandwidth requirements (e.g., the continuous capture of full-resolution and display or preview images), it may be beneficial to obtain full-resolution and display-resolution or preview images at the same time from the image capture circuitry—writing both to memory at virtually the same time. The display resolution image may then be delivered to a display unit directly without the need for additional memory operations on the full-resolution image. Only when a user indicates they wish to capture an image need additional memory operations on the full-resolution image be performed. The savings in run-time bandwidth over the prior art can be substantial.

In one embodiment an image capture device and method are described that: receive full-resolution RAW and preview images representing a scene from an integrated sensor package; stores the full-resolution RAW and preview images in a memory; and transfers the preview image from the memory to a display device for display. When user input is received indicating the desire to capture an image associated with the currently displayed scene (e.g., corresponding to the currently displayed preview image), the full-resolution RAW image may be encoded into any desired format, whereafter the encoded image may be stored in memory.

### BRIEF DESCRIPTION OF THE DRAWINGS

FIG. 1 shows, in block diagram form, a prior art image capture device.

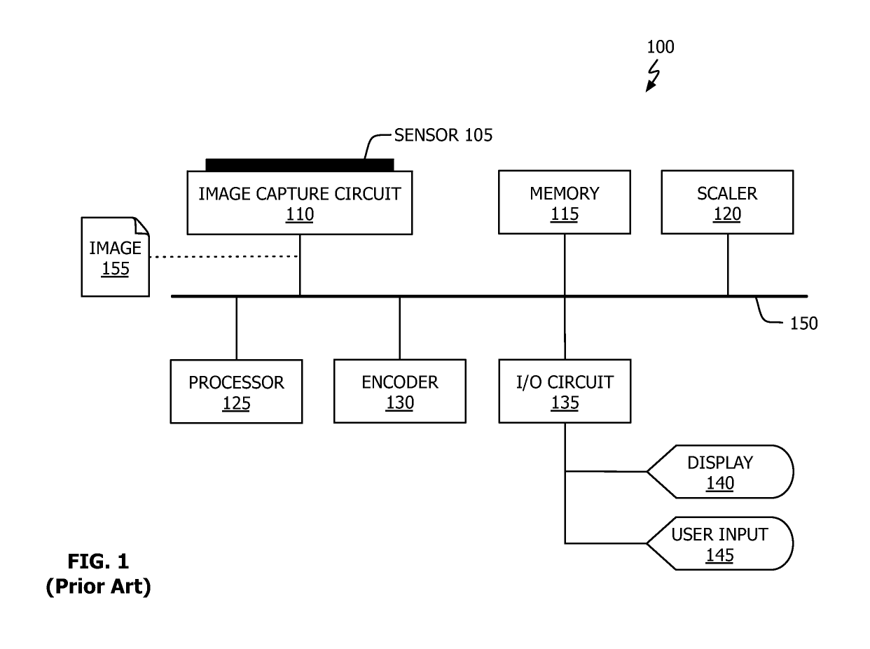

FIG. 2 shows a single image capture sequence for the image capture device of FIG. 1.

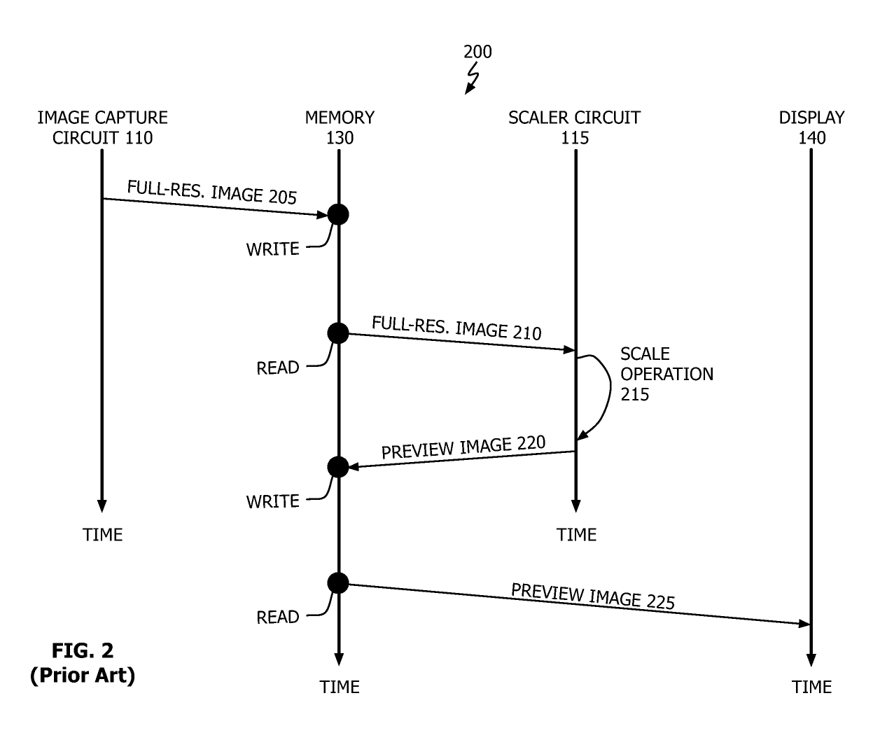

FIG. 3 shows an image capture device in accordance with one embodiment.

FIG. 4 shows a sequence of image capture operations for the image capture device of FIG. 3.

FIG. 5 shows, in flowchart form, an image capture process in accordance with one embodiment.

### DETAILED DESCRIPTION

Techniques are described that can dramatically reduce the amount of data transport required in an image capture device. As the resolution of digital image capture devices increase, the bandwidth needed to support this increased resolution is becoming increasingly difficult to support. To reduce the problems associated with run-time bandwidth requirements (e.g., the continuous capture of full-resolution and display or preview images), it may be beneficial to obtain full-resolution RAW and display-resolution or preview images at the same time from the image capture circuitry—writing both to memory at virtually the same time. The display resolution image may then be delivered to a display unit directly without the need for additional memory operations on the full-resolution RAW image. Only when a user indicates they wish to capture an image need additional memory operations on the full-resolution RAW image be performed. The savings in run-time bandwidth over the prior art can be substantial.

In the following description numerous specific details are set forth in order to provide a thorough understanding of the inventive concept. It will be apparent to one skilled in the art, however, that the invention may be practiced without these specific details. In other instances, structure and devices are shown in block diagram form in order to avoid obscuring the invention. It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the image processing field having the benefit of this disclosure.

References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

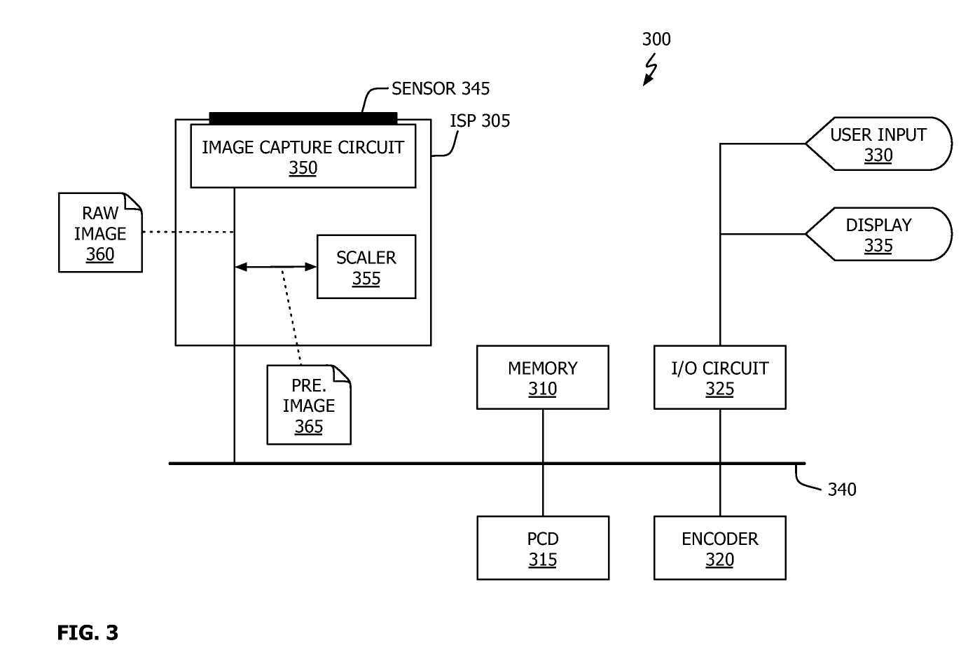

Referring to FIG. 3, image capture device 300 (e.g., a still or video camera) in accordance with one embodiment includes integrated sensor package (ISP) 305, memory 310, programmable control device (PCD) 315, encoder 320, I/O circuit 325, user input device (e.g., a push-button or touch-screen) 330, display unit 335 and internal bus 340. ISP 305 itself includes sensor array 345, image capture circuit 350 and scaler circuit 355. During operation, image capture circuit 350 generates full-resolution RAW formatted image 360 and streams the image into memory 310 and into the input of scaler circuit 355 at substantially the same time. Scaler circuit 355 generates preview image 365 that is the proper size, format and color space suitable for display on display unit 335.

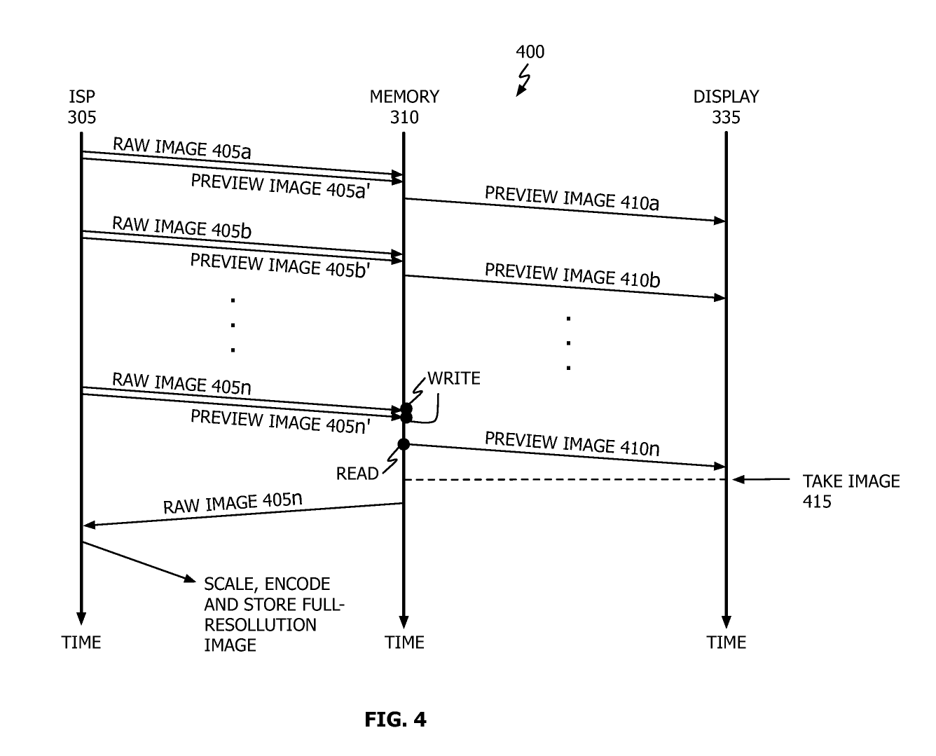

Referring to FIG. 4, the data flow across bus 340 is illustrated as a sequence of writes (405a/405a′-405n/405n′) and read (410a-410n) operations. Eventually, a user indicates they wish to “take a picture” 415 (e.g., through input device 330 and I/O circuit 325). At that time, the currently displayed preview image's (e.g., that image written to display 335 at 410n) associated RAW image (e.g., that RAW image written to memory 310 at 405n) is transferred from memory 310 to encoder circuit 355 in ISP 305 where it is converted into a full resolution image in a format suitable for input to encoder circuit 320 (e.g., 4:2:0 YCbCr format; also referred to as YUV 420 format). From scaler circuit 350 the image may be streamed/transferred to encoder circuit 320 where it is converted to a desired format (e.g., JPEG, Exif or EXchangeable Image File format, TIFF or Tagged Image File Format, PNG or Portable Network Graphics format, BMP or Windows file format, and GIF or Graphics Interchange Format). The converted image then being stored in memory 310. As can be seen from FIG. 4, during normal run operations (before the user indicates they wish to take a picture), each image capture is associated with a single write of the full-resolution RAW image (e.g., 405n), and 1 write and 1 read of the preview image (e.g., 405n′ and 410n respectively).

Table 3, identifies the bandwidth requirements for data flow 400 under the following assumptions: (1) the full-resolution RAW image is 2048×1536 pixels (3 megapixels) and is encoded using 2 bytes per pixel; (2) the preview image is 852×640 pixels and is encoded in 4:2:0 YCbCr format using 1.5 bytes per pixel; and (3) the image capture rate is 15 frames per second. Table 4, identifies the bandwidth requirements for data flow 400 under the same assumptions except that the full-resolution RAW image is now 2592×1936 pixels (5 megapixels).

TABLE 3
Example Bandwidth Requirement for Image Capture
Operations in Accordance With One Embodiment
For a 3 Megapixel Image Capture Device

| Image | Size | | Bytes/Pixel | Read | Write | Bytes/sec |
|---|---|---|---|---|---|---|
| RAW | 2048 | 1536 | 2 | 0 | 1 | 94,371,840 |
| Preview | 852 | 640 | 1.5 | 1 | 1 | 24,537,600 |

| | |
|---|---|
| Total Bandwidth (Bytes/sec): | 118,909,440 |
| Total Bandwidth (MB/sec): | 113.4 |

TABLE 4
Example Bandwidth Requirement for Image Capture
Operations in Accordance With One Embodiment
For a 5 Megapixel Image Capture Device

| Image | Size | | Bytes/Pixel | Read | Write | Bytes/sec |
|---|---|---|---|---|---|---|
| RAW | 2592 | 1936 | 2 | 0 | 1 | 150,543,360 |
| Preview | 852 | 640 | 1.5 | 1 | 1 | 24,537,600 |

| | |
|---|---|
| Total Bandwidth (Bytes/sec): | 250,352,640 |
| Total Bandwidth (MB/sec): | 166.97 |

Table 5 shows the savings in run-time bandwidth afforded by an image capture process in accordance with various embodiments assuming: (1) the preview image is 852×640 pixels and is encoded in 4:2:0 YCbCr format using 1.5 bytes per pixel; and (2) the image capture rate is 15 frames per second. As used herein, the phrase “run-time bandwidth” refers to the bandwidth required during image capture operations before a user indicates they wish to take a picture (e.g., during operations 405a/405a′-410n). As can be seen, the savings can be significant.

TABLE 5
Run-time Bandwidth Savings

| | Prior Art BW | Run-Time | |
|---|---|---|---|
| | Run-Time | Bandwidth | |
| | Bandwidth | Requirements | |
| Full-Res. | Requirements | in Accordance with | |
| Image | (MB/sec) | Embodiments (MB/sec) | %-Savings |
| 3 Mpixels | 158.4 | 113.4 | 28.4 |
| 5 Mpixels | 238.75 | 166.97 | 30 |

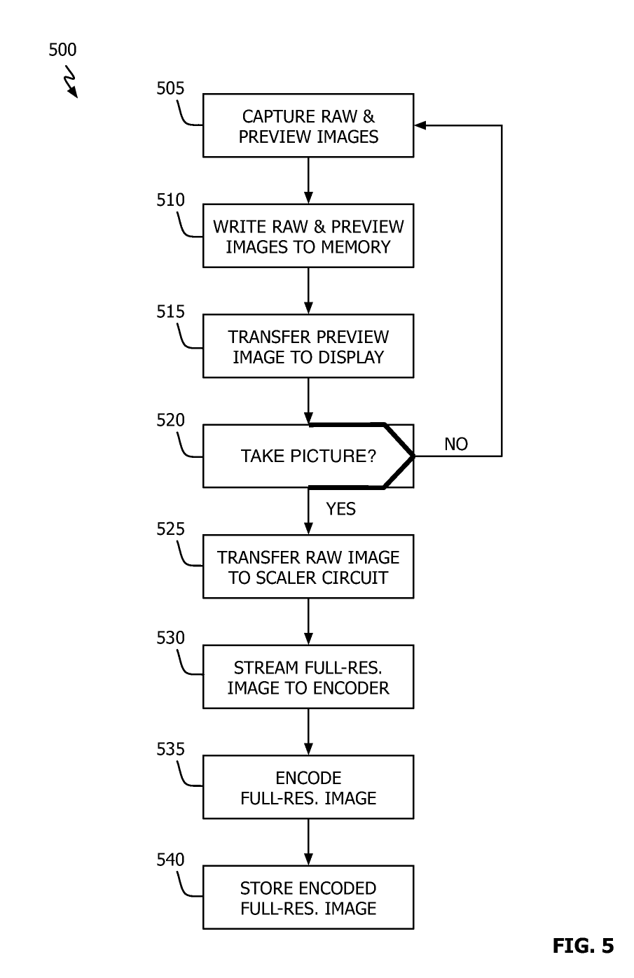

Referring to FIG. 5, image capture sequence 500 in accordance with one embodiment begins by capturing both full-resolution RAW 360 and preview 365 images at substantially the same time (block 505) and writing them to memory 310 (block 510). The preview image is then written/transferred to display unit 335 via I/O circuit 325 (block 515). If the user does not indicate they wish to retain (i.e., “capture”) the currently displayed scene (the “NO” prong of block 520), acts in accordance with blocks 505-515 are repeated. If the user does indicate they wish to capture the currently displayed scene (the “YES” prong of block 520), that full-resolution RAW image corresponding to the currently displayed preview image is transferred from memory 310 to scaler circuit 355 in ISP 350 where, in one embodiment, it is converted to a full resolution 4:2:0 YCbCr format image using 1.5 bytes per pixel (block 525). From scaler circuit 355, the full-resolution image is streamed to encoder circuit 320 (block 530) where it is converted to a desired format such as, for example, JPEG (block 535). Finally, the encoded full-resolution image is written back to memory 310 (block 540). One of ordinary skill will understand that when full-resolution RAW image 360 is transferred from memory 310 to ISP 305/encoder circuit 335 during acts in accordance with block 525, metadata associated with the RAW image is also transferred back to ISP 305/encoder circuit 335 to permit the conversion. This metadata is captured at the same time as the full-resolution RAW image and permits the “resetting” of the ISP to the state it was in when the RAW image was originally captured.

Referring to FIGS. 3 and 5, one of ordinary skill will recognize that memory 310 may comprise multiple modules or units each of which may be of a different type (e.g., volatile and non-volatile) and be separately addressable by either ISP 305 or PCD 315. It will be similarly recognized that PCD 315 may be a single computer processor, a special purpose processor (e.g., a digital signal processor or an embedded processor), a plurality of processors coupled by a communications link or a custom designed state machine. Computer processors include, for example, one or more members of the Intel Atom®, Core®, Pentium and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Custom designed state machines may be embodied in a hardware devices such as one or more application specific integrated circuits (ASICs) or field programmable gate arrays (FPGAs).

Image capture process 500 in accordance with this disclosure may be performed by a programmable control device executing instructions organized into one or more program modules. Storage devices suitable for tangibly embodying program instructions (e.g., memory 310) include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”) and flash devices.

Various changes in the materials, components, circuit elements, as well as in the details of the illustrated operational methods are possible without departing from the scope of the following claims. For instance, ISP 305 may include other functionality not discussed herein. Further, encoder circuit 320 functionality may be incorporated within ISP 305. In addition, the resolution of sensor 345 is not limited to 3 or 5 megapixels—these values being used here simply for illustrative purposes. Finally, it is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. An image capture system, comprising:
an image sensor;
an integrated sensor package coupled to the image sensor;
memory coupled to the integrated sensor package; and
a programmable control device coupled to the integrated sensor package and memory, the memory including instructions for causing the programmable control device to—
receive, from the integrated sensor package, a first full-resolution image representing a scene;
store the first full-resolution image in the memory,
receive, from the integrated sensor package, a preview image representing the scene,
store the preview image in the memory, and
transfer the preview image from the memory to a display device.

2. The image capture system of claim 1, further comprising an encoder circuit coupled to the integrated sensor package, the memory and the programmable control device, the memory further comprising instructions for causing the programmable control device to—
receive user input while the preview image is displayed on the display device;
transfer the first full-resolution image from the memory to the integrated sensor package;
transfer a second full-resolution image from the integrated sensor package to the encoder circuit, the second full-resolution image representing the scene and having a format different from that of the first full-resolution image;
receive an encoded image from the encoder circuit; and
store the encoded image in the memory.

3. The image capture system of claim 1, wherein the instructions for causing the programmable control device to receive a first full-resolution image comprises instructions to receive a RAW formatted image.

4. The image capture system of claim 1, wherein the instructions for causing the programmable control device to receive a preview image comprises instructions to receive a 4:2:0 YCbCr formatted image.

5. The image capture system of claim 1, wherein the integrated sensor package, memory and programmable control device are incorporated in a mobile telephone.

6. The image capture system of claim 1, wherein the integrated sensor package, memory and programmable control device are incorporated in a personal entertainment device.

7. The image capture system of claim 1 comprising a digital still camera.

8. The image capture system of claim 1 comprising a digital video camera.

9. An image capture method, comprising;
receiving, from an integrated sensor package, a full-resolution image and a preview image representing a scene at substantially the same time, the full-resolution image having a first format;
storing the full-resolution image and the preview image in a memory;
transferring the preview image from the memory to a display device.

10. The method of claim 9, further comprising:
receiving user input while the preview image is displayed on the display device;
transferring the full-resolution image from the memory to the integrated sensor package where the full-resolution image is converted to a second format;
transferring the full-resolution image in the second format from the integrated sensor package to an encoder circuit;
receiving an encoded image from the encoder circuit in response to receiving the full-resolution image in the second format; and
storing the encoded image in the memory.

11. The method of claim 9, wherein the act of receiving a full-resolution image comprises receiving a RAW formatted image.

12. The meth of claim 9, wherein the act of receiving a preview image comprises receiving a 4:2:0 YCbCr formatted image.

13. The method of claim 9, wherein the acts of receiving, storing and transferring are performed by an image capture device in a mobile telephone.

14. The method of claim 9, wherein the acts of receiving, storing and transferring are performed by a digital still camera.

15. The method of claim 9, wherein the acts of receiving, storing and transferring are performed by a digital video camera.

16. A program storage device, readable by a programmable control device, comprising instructions stored therein for causing the programmable control device to perform the method of claim 9.

17. An image capture method, comprising:
receiving, from an integrated sensor package, a full-resolution image having a first format and a corresponding preview image representing a scene at a first time;
storing the full-resolution image and the corresponding preview image in a memory;
transferring the corresponding preview image from the memory to a display device; and
repeating the acts of receiving, storing and transferring at a specified rate until a user input is received, after which—
delivering a full-resolution image corresponding to a currently displayed preview image from the memory to the integrated sensor package,
obtaining, from the integrated sensor package, a full-resolution image in a second format in response to the act of delivering, wherein the full-resolution image in the second format corresponds to the currently displayed preview image,
encoding the full-resolution image in the second format to a third format, and
writing the encoded full-resolution image to the memory.

18. The method of claim 17, wherein the act of receiving a full-resolution image having a first format comprises receiving a RAW formatted full-resolution image.

19. The method of claim 18, wherein the act of obtaining a full-resolution image in a second format comprises obtaining a full-resolution image in a 4:2:0 YCbCr format.

20. The method of claim 19, wherein the act of encoding the full-resolution image in the second format to a third format, comprises encoding the 4:2:0 YCbCr format full-resolution image to a JPEG formatted image.

21. The method of claim 17, wherein the act of receiving a preview image comprises receiving a 4:2:0 formatted YCbCr preview image.

22. A program storage device, readable by a programmable control device, comprising instructions stored therein for causing the programmable control device to perform the method of claim 17.
